(19) United States
(12) Patent Application Publication
(10) Pub. No.: US 2009/0200099 A1
(43) Pub. Date: Aug. 13, 2009

(54) ELECTRIC POWER STEERING CONTROL SYSTEM

(76) Inventors: Ray Tat-Lung Wong, Richmond (CA); Anson Chin Ping Chan, Richmond (CA)

Correspondence Address: CAMERON IP, SUITE 1401 - 1166 ALBERNI STREET, VANCOUVER, BC, V6E 3Z3, CA

(21) Appl. No.: 12/368,227

(22) Filed: Feb. 9, 2009

Related U.S. Application Data
(60) Provisional application No. 61/027,799, filed on Feb. 11, 2008.

(51) Int. Cl. B62D 5/04; B62D 6/00

(52) U.S. Cl. 180/446; 701/42

(57) ABSTRACT

An electric power steering control system for a vehicle that has a steering device coupled by a steering assembly to at least one tire steered by the steering device. The control system controls a current in a motor for generating torque applied to the steering assembly. The control system comprises a feed-forward component that generates a torque target signal representative of the torque applied by the motor to the steering assembly. The torque target signal is proportional to a multiplication of a steering torque from the steering device. There is also a sensor component that senses the motor current and provides a motor current signal. A motor control component receives the torque target signal and the sensed motor signal. The motor current signal is driven towards a value wherein the torque target signal is equal to a multiplication factor of the motor current signal.

### CROSS-REFERENCE TO RELATED APPLICATION

This application claims the benefit of provisional application 61/027,799 filed in the United States Patent and Trademark Office on Feb. 11, 2008, the complete disclosure of which is incorporated herein by reference and priority to which is claimed pursuant to 35 U.S. C. section 120.

### BACKGROUND OF THE INVENTION

1. Field of the Invention

The present invention relates generally to electric power steering control systems for vehicles and, in particular, to electric power steering control systems for vehicles with handle bars that control the current in a motor used to apply assist torque or damping torque to the handle bars depending upon the circumstance.

2. Description of the Related Art

It has been known to use a motor in an electric power steering system to provide steering assist functionality. The motor typically provides resistance during the return to center phase of steering to resist the normal return of the steering wheel to the neutral position after a turn. The motor has also been used to provide an assist torque during this phase to overcome the inherent resistance of the motor. Various schemes have been used to control the motor in an electric power steering system.

U.S. Pat. No. 5,668,721 issued Sep. 16, 1998 to Ashok Chandy discloses an electric power steering control system that provides both a voltage mode and a current mode of motor control. The first mode of motor control is a voltage mode in which the motor is commanded with a voltage command based on the desired level of assist torque, used during high steering gain events. The second mode of motor control is a current mode in which the motor is commanded with a current command based on the desired level of assist torque, used for low gain torque assist steering events. However, this system of motor control in an electric power steering system may become unstable when crossing from one mode of control to another mode of control.

There is accordingly a need for an improved system of motor control for an electric power steering system during both low and high gain assist events.

### BRIEF SUMMARY OF INVENTION

It is an object of the present invention to provide an improved system of motor control for an electric power steering system which gives a smooth, continuous control function which is substantially free from potential oscillations during different steering events.

There is accordingly provided an electric power steering control system for a vehicle having a steering device coupled by a steering assembly to at least one tire steered by the steering device. The control system controls a current in a motor for generating torque applied to the steering assembly. The control system comprises a feed-forward component that generates a target torque signal representative of the torque applied by the motor to the steering assembly. The target torque signal is a multiplication of a steering torque from the steering device. There is also a sensor component that senses the motor current and provides a motor current signal. A motor control component receives the target torque signal and the sensed motor signal. The motor current signal is driven towards a value wherein the target torque signal is equal to a multiplication factor of the motor current signal.

There is also provided an electric power steering control system for a vehicle having a steering device coupled by a steering assembly to at least one tire steered by the handle bar. The control system controls a motor for generating a torque applied to the steering assembly. The control system comprises a steering torque sensor for sensing steering torque generated by a driver of the steering device. The steering torque sensor provides a steering torque signal. A vehicle speed sensor provides a vehicle speed signal representative of the vehicle speed. A steering shaft angle sensor senses the angular displacement of the handle bars and provides a steering shaft angle signal. A feed forward component generates a target torque assist signal representative of the torque applied to the steering assembly. The feed forward component receives the steering torque signal, the car speed signal, and the steering shaft angle signal. A current sensor senses the current in the motor and provides a motor current signal. A control component controls the motor whereby the torque applied to the steering assembly is related to the target torque assist signal by a multiplication factor. The control component receives the target torque assist signal and the motor current signal, and provides a motor control signal.

There is further provided a method of controlling an electric power steering system for a vehicle. The method comprises the steps of generating a target torque signal representative of the torque applied by the motor to the steering assembly, the target torque signal being a multiplication of a steering torque from the steering device; sensing a current of the motor and providing a motor current signal; and controlling the motor whereby the current is driven towards a value wherein the target torque signal is equal to a multiplication factor of the motor current signal.

The present electric power steering control system uses a larger gear ratio gearbox which allows the motor to operate near its optimal rpm specification. The higher gear ratio also provides increased damping during road disturbance events, increased torque assist, and allows the vehicle to be assigned a more neutral castor for increased stability and reduced steering effort. The larger gear ratio gearbox also allows for a reduced current in the motor thereby reducing operating temperature and allowing for a smaller motor to be used.

It is an advantage of the present invention to provide an electric power steering control system having steering assist, steering damping, and steering return functionality. It is another advantage of the present invention to provide a smooth transition between these functions. It is a still another advantage of the present invention to provide a pure torque multiplier for steering assist. It is yet still another advantage of the present invention to minimize electric power steering resistance effect for steering return, and to provide steering damping for disturbance rejection.

### BRIEF DESCRIPTION OF DRAWINGS

The invention will be more readily understood from the following description of preferred embodiments thereof given, by way of example only, with reference to the accompanying drawings, in which:

FIG. 1 is a block diagram of an improved electric power steering system;

FIG. 2 is an alternative block diagram of the electric power steering system of FIG. 1;

FIG. 3 is a flowchart diagram of a feed-forward controller algorithm of the electric power steering system of FIG. 1;

FIG. 4 is a flowchart diagram of an assist torque feedback component algorithm of the electric power steering system of FIG. 1;

FIG. 5 is a flowchart diagram of a feed back controller algorithm of the electric power steering system of FIG. 1;

FIG. 6 is a schematic view of an equivalent simplified circuit of a motor of the electric power steering control system of FIG. 1;

FIG. 7a, 7b and 7c are voltage wave diagrams across elements of the equivalent simplified circuit of the motor of FIG. 1;

FIG. 8 is a current wave diagram of the circuit of FIG. 6; and

FIG. 9 is a view of a vehicle provided with the electric power steering system of FIG. 1.

### DESCRIPTION OF THE PREFERRED EMBODIMENTS

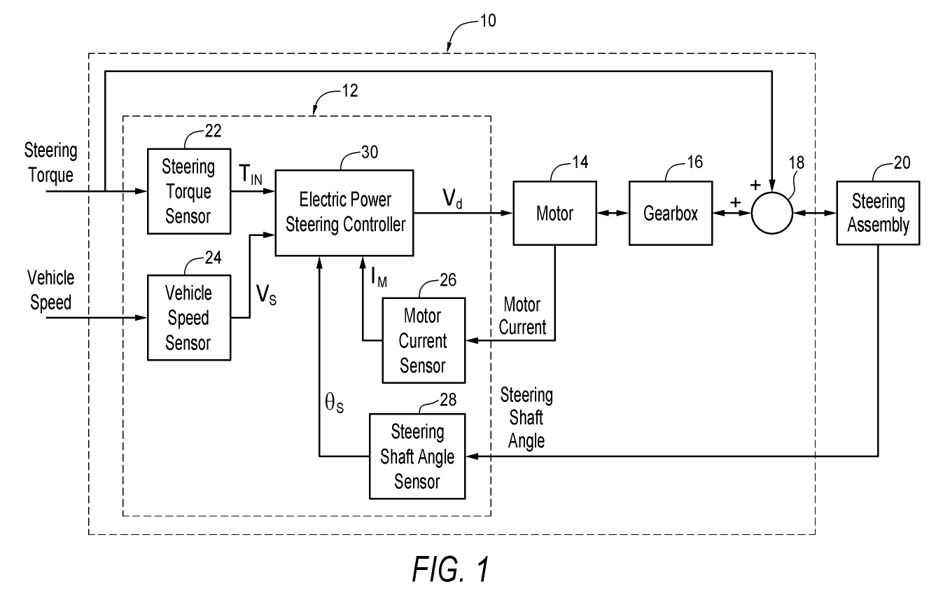

Referring to the drawings and first to FIG. 1, an electric power steering system indicated generally by reference numeral 10 is shown. The electric power steering system 10 includes a control system 12, a motor 14, a gearbox 16, and a steering column 18. The steering column 18 is connected with a steering assembly 20 for turning the steering tires of a vehicle. Such steering assemblies are well known in the art and accordingly steering assembly 20 is not described in detail herein.

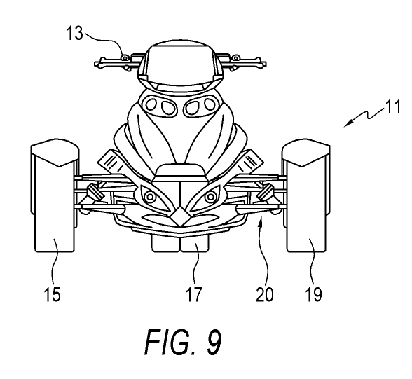

Referring now to FIG. 9 a vehicle 11 provided with the power steering system is shown. The vehicle 11 includes handlebars 13 and wheels 15, 17, and 19. The steering assembly is shown at 20.

Referring back to FIG. 1, the electric power steering system 10 operates continuously over three phases of steering activity, namely, steering assist, steering return, and steering damping. Steering assist occurs when a driver of the vehicle applies torque to a steering device, e.g. handle bars 13 shown in FIG. 9. In order to steer the wheels 15 and 17 and turn the vehicle 11. In this situation, the electric power steering system 10 provides an assist torque to the steering assembly 20 thereby decreasing the amount of torque the driver must apply in order to turn the vehicle.

The steering return phase begins when the driver stops applying steering torque to the handle bars while the tires are still in an off center position. Road geometry generates a back driving alignment torque which tends to steer the wheels back to the neutral position, i.e. such that the vehicle will continue in a straight line. However, electric power steering systems have a built in resistance to the back driving alignment torque, which prevents the tires from returning immediately to the neutral position, causing the vehicle to continue to turn. In this situation the electric power steering system 10 generates an assist torque to counter balance the back driving torque thereby allowing the vehicle tires to return to the neutral position such that the vehicle continues in a straight line.

Steer dampening occurs when the vehicle encounters an external disturbance in the road which generates a strong back driving torque that has the effect of turning the handle bars. Examples of external road disturbances include the vehicle hitting a rock or driving on a tractor track. In these situations the vehicles are typically travelling at a high speed and the steering angle rate is higher than is normally obtained from human input or back driving alignment torque geometry. In general, high steering stability is required during high vehicle speeds. The electric power steering system 10 generates a damping torque braking effect on the motor 14 to counteract and prevent the road disturbance torque from turning the handle bars. The damping torque is directly proportional to the induced speed of the motor. The active damping function allows the castor of the vehicle to be reduced thereby reducing low speed steering effort while not compromising high speed stability.

Referring again to FIG. 1, the control system 12 comprises a steering torque sensor 22, a vehicle speed sensor 24, a motor current sensor 26, a steering shaft angle sensor 28, and an electric power steering controller 30. The steering torque sensor 22 senses the torque applied to the steering device, e.g. the handle-bars (not shown), by a driver of the vehicle and provides a steering torque signal T_{IN}. The vehicle speed sensor 24 provides a vehicle speed signal V_{S} representative of the vehicle speed. The motor current sensor 26 senses the current of the motor 14 and provides a motor current signal I_{M}. The steering shaft angle sensor 28 senses the angular displacement of a shaft of the steering column 18 and provides a steering shaft angle signal θ_{S}. The electric power steering controller 30 receives the signals T_{IN}, V_{S}, θ_{S} and I_{M} and provides a motor control signal V_{d}.

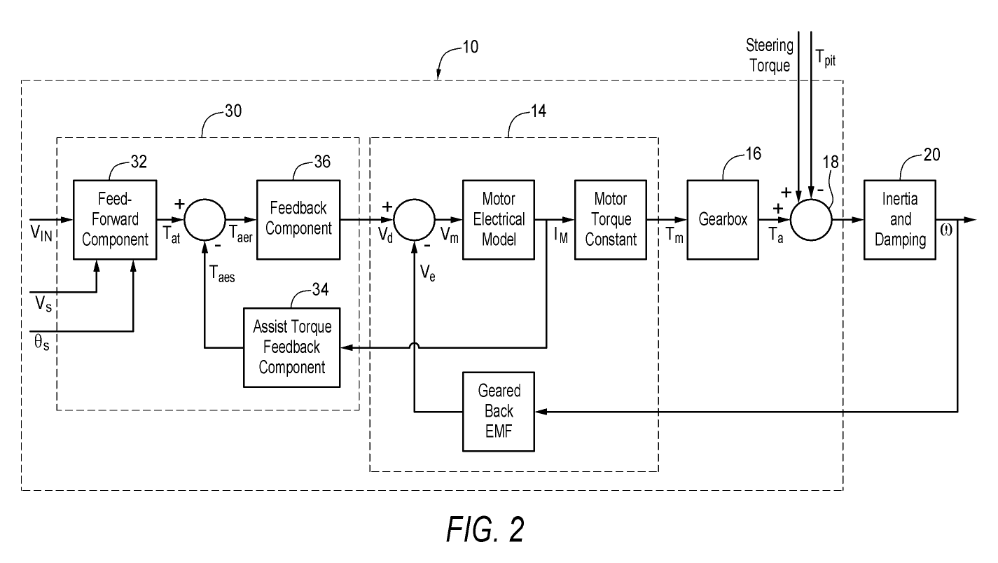

Referring now to FIG. 2, the electric power steering system 10 is described in more detail using an alternative view thereof in which the sensors 22, 24, 26 and 30 are omitted. It is understood by those skilled in the art that the electric power steering controller 30 can be implemented in either analog or digital form, or a combination of both. The description provided hereunder emphasizes a digital embodiment by way of example only. The electric power steering controller 30 comprises a feed-forward component 32, an assist torque feedback component 34, and a feedback component 36. The feed-forward component 32 receives the steering torque signal T_{IN}, the vehicle speed signal V_{S}, and the steering shaft angle signal θ_{S} and provides an assist torque target signal Tₐₜ. The assist torque feedback component 34 receives the motor current signal I_{M} and provides an estimated assist torque signal Tₐₑₛ. The assist torque target signal Tₐₜ and the estimated assist torque signal Tₐₑₛ are added to each other to generate an assist torque error signal Tₐₑᵣ. The feedback component 36 receives the assist torque assist error signal Tₐₑᵣ and provides the motor control signal V_{d}.

The steering torque signal T_{IN} multiplied by the transfer function of the feed-forward component 32 equals the assist torque target signal Tₐₜ. The feed-forward component 32, which can also be called a torque multiplier, simulates pure power assist steering and in the present embodiment is a tunable map which takes as inputs the vehicle speed signal V_{S} and the steering shaft angle signal θ_{S}. The transfer function of the feed-forward component 32 is a continuous function which can be characterized in the three regions of steering operation described above as outlined in Table 1 below for different steering events.

TABLE 1

| Target Torque assist | | Region of Operation |
|---|---|---|
| (Tₐₜ) | Conditions | (Steering Event) |
| Tₐₜ > 0 | T_{IN} > 0 | Assist |
| | Vₛ < speed limit | |
| Tₐₜ = 0 | T_{IN} = 0 | Return |
| | Vₛ < speed limit | |
| Tₐₜ < 0 | Vₛ > speed limit or | Damping |
| | θₛ > angle rate limit | |

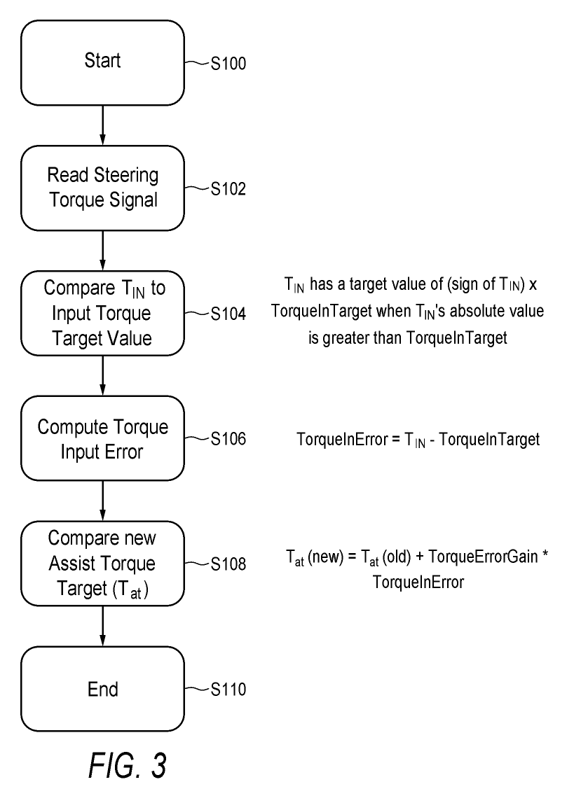

Referring to FIG. 3, the algorithm of the transfer function of the feed forward component 32 is described. The steering torque signal T_{IN} is read in step S102 and is compared to an input torque target value in step S104. The magnitude of the steering torque signal T_{IN} is limited to the absolute value of the input torque target value. The torque input error is calculated in step S106. The new assist torque target Tₐₜ is calculated in step S108 by adding an old assist torque target signal to the product of the torque input error and a torque error gain factor, comparable to an integrator function.

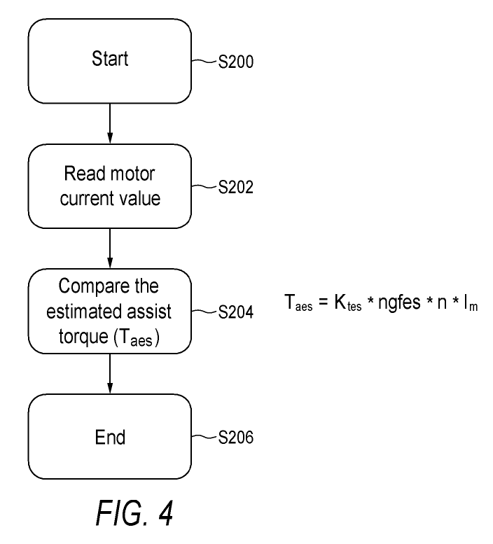

Referring to FIGS. 2 and 4, the algorithm of the transfer function of the assist torque feedback component 34 is now described. The motor current I_{M} multiplied by the transfer function of the assist torque feedback component 34 equals the estimated assist torque signal Tₐₑₛ. The motor current I_{M} is read in step S202. The estimated assist torque signal Tₐₑₛ is calculated in step S204 by multiplying the estimated torque constant Kₜₑₛ by the estimated forward gear efficiency (ηgfes) and the gear ratio (n) and the motor current signal I_{M}.

As indicated above the assist torque feedback component 34 multiplies the motor current I_{M} by an estimated torque constant Kₜₑₛ, gear ratio and gear efficiency to calculate the estimated assist torque Tₐₑₛ. The motor current I_{M} is positive when forward driving, i.e. motor 14 driving gearbox 16, and negative when backward driving, i.e. gearbox 16 driving the motor 14. The estimated gear efficiency ηg is equal to the estimated forward gear efficiency (ηgfes) when the motor current I_{M} is greater than zero, and is equal to the estimated backward gear efficiency (ηgbes) when the motor current Iₘ is less than zero. The estimated gear efficiency ηg is speed dependent, and the torque constant Kₜ is temperature dependent.

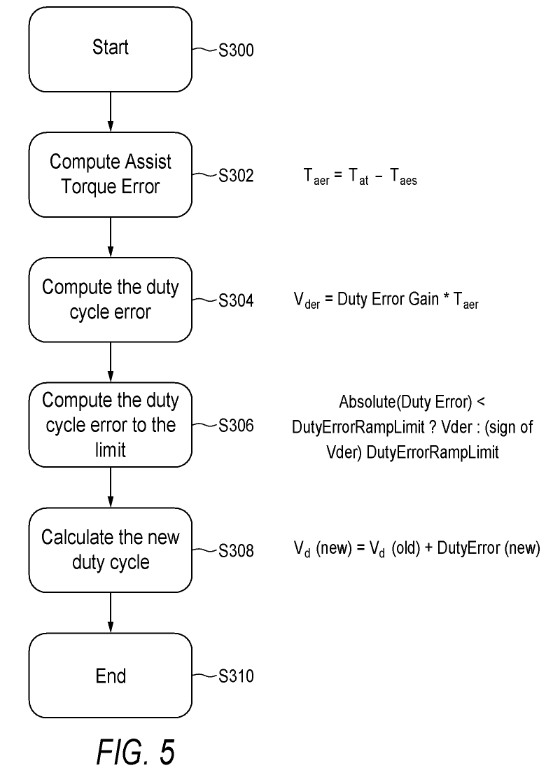

Referring now to FIGS. 2 and 5, the algorithm of the transfer function of the feedback component 36 is now described. The assist torque error signal Tₐₑᵣ multiplied by the transfer function of the feedback component 36 equals the motor control signal V_{d}. The assist torque error signal Tₐₑᵣ is calculated in step S302 by subtracting the assist torque target signal Tₐₜ from the estimated assist torque signal Tₐₑₛ. A duty cycle error signal V_{der} is calculated in step S304 by multiplying the assist torque error signal Tₐₑᵣ by a duty error gain constant, and the result is limited in magnitude in step S306. The new duty cycle is calculated in step S308, where an old duty cycle value is added to the duty cycle error signal. This function comparable to an integrator function. The feedback component 36 is a series of tunable maps in the present embodiment.

The operation of the electric power steering control system 10 is described for steering return. The steering torque input T_{IN} is zero during steering return. However, due to road geometry there is a back driving alignment torque that creates a pitman torque Tₚᵢₜ. The pitman torque Tₚᵢₜ drives the inertia and damping of the mechanical system, i.e. the motor 14, the gearbox 16, the handle bar 13, the steering column 18, the linkages, tires 15 and 19, and drives the steering shaft at an angular rate ω. The shaft angular rate ω multiplied by a motor velocity constant and the gear ratio equals the back e.m.f voltage Vₑ which feeds back to the motor creating the motor current I_{M}, which further resists the return to center of the steering system. The assist torque feedback component 34 senses the motor current I_{M} which results in an assist torque error signal Tₐₑᵣ that is multiplied by the feedback component 36 thereby creating the motor control signal V_{d}, which counteracts the back e.m.f voltage Vₑ. The effect on the motor current I_{M} of this feedback is to drive the average motor current towards zero, when the steering torque signal T_{IN} is zero. The perception to the driver of the vehicle is that there is no effort required from them to return the handle bars to neutral, thereby the steering column 18 appears to free spin simulating non-power steering assist vehicles.

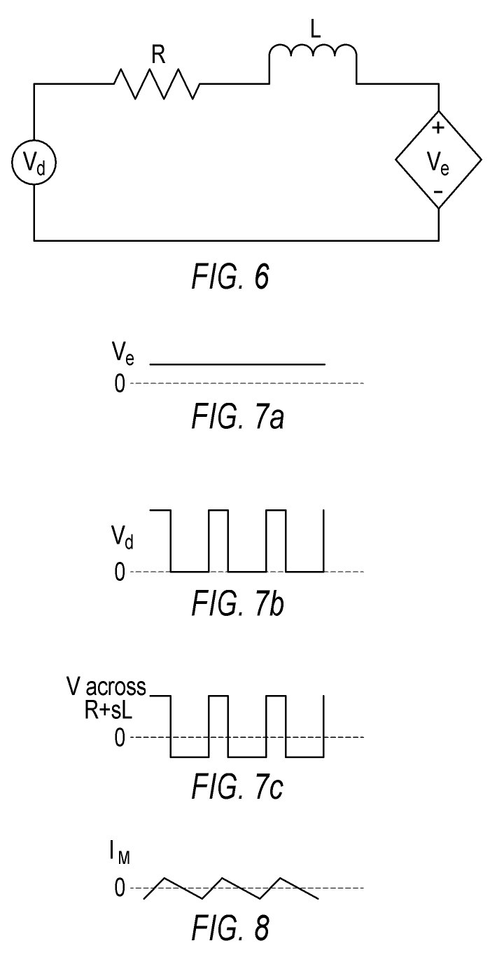

Referring to FIG. 6, there is shown an equivalent simplified circuit of the motor 14 with the motor control signal V_{d} applied. The motor 14 includes an equivalent series resistance R and an equivalent series inductance L. The back e.m.f voltage Vₑ, illustrated in FIGS. 6 & 7a, first generates the motor current Iₘ causing a torque which tends to oppose the action of the pitman torque Tₚᵢₜ. However, due to the feedback described above, a pulse width modulated voltage signal is input to the motor as the motor control signal V_{d}, illustrated in FIG. 7b, which tends to counteract the effect of the back e.m.f voltage Vₑ. The total voltage across the equivalent resistance R and equivalent inductance L of the motor 14 is shown in FIG. 7c. Referring to FIG. 8, the motor current Iₘ across the motor equivalent circuit in FIG. 6 is shown, which has an average value substantially close to zero, in the situation when the steering torque signal T_{IN} is zero.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof. As is readily apparent the system and method of the present invention is advantageous in several aspects.

What is claimed is:

1. An electric power steering control system for a vehicle, the vehicle having a steering device coupled by a steering assembly to at least one tire steered by the steering device, the control system controlling a current in a motor for generating torque applied to the steering assembly, and the control system comprising:
means for generating a torque target signal representative of the torque applied by the motor to the steering assembly, the torque target signal being a multiplication of a steering torque from the steering device;
means for sensing the motor current and providing a motor current signal; and
means for controlling the motor receiving the torque target signal and the sensed motor signal, whereby the motor current signal is driven towards a value wherein the torque target signal is equal to a multiplication factor of the motor current signal.

2. The electric power steering control system of claim 1 further including a vehicle speed sensor providing a speed signal representative of the speed of the vehicle, and a steering angle sensor providing a steering angle signal representative of the steering angle of the steering device, wherein the vehicle speed signal and the steering angle signal are received by the means for generating a torque target signal.

3. The electric power steering control system of claim 2 wherein the means for generating a torque target signal includes means for differentiating between steering events, said means for differentiating between steering events receiving a steering torque signal, the vehicle speed signal and the steering angle signal.

4. The electric power steering control system of claim 1 wherein the means for controlling the motor includes means for generating an estimated assist torque signal, said means for generating an estimated assist torque signal receiving the motor current signal.

5. The electric power steering control system of claim 4 further including a feedback component receiving the difference between the target torque signal and the estimated assist torque signal, the feedback component providing a motor control signal.

6. The electric power steering control system of claim 5 wherein the feedback component includes an integrator.

7. The electric power steering control system of claim 1 wherein the means for generating the torque target signal includes an integrator.

8. The electric power steering control system of claim 1 wherein the means for generating the torque target signal limits the torque target signal to a maximum value.

9. The electric power steering control system of claim 4 wherein the means for generating an estimated assist torque signal includes multiplication means for multiplying the motor current signal by the product of an estimated torque constant, an estimated gear efficiency and a gear ratio, the estimated gear efficiency and the gear ratio being quantitative characteristics of a gearbox coupling the motor to the steering assembly.

10. The electric power steering control system of claim 5 wherein the feedback component includes means for generating a duty cycle error signal.

11. The electric power steering control system of claim 10 wherein the feedback component further includes means for adding the duty cycle error signal to an old motor control signal, thereby generating the motor control signal.

12. An electric power steering control system for a vehicle having a steering device coupled by a steering assembly to at least one tire steered by the handle bar, the control system controlling a motor for generating torque applied to the steering assembly, the control system comprising:
a steering torque sensor for sensing steering torque generated by a driver of the steering device, the steering torque sensor providing a steering torque signal;
a vehicle speed sensor providing a vehicle speed signal representative of the vehicle speed;
a steering shaft angle sensor sensing the angular displacement of the steering device and providing a steering shaft angle signal;
a feed forward component generating an assist torque target signal representative of the torque applied to the steering assembly, the feed forward component receiving the steering torque signal, the vehicle speed signal and the steering shaft angle signal;
a current sensor for sensing the current in the motor and providing a motor current signal;
means for controlling the motor whereby the torque applied to the steering assembly is proportional to a multiplication factor of the assist torque target signal, the means for controlling the motor receiving the assist torque target signal and the motor current signal, and providing a motor control signal.

13. A method of controlling an electric power steering system for a vehicle during the return to center phase of a steering assembly of the vehicle, the electric power steering system controlling a current in a motor for generating torque applied to the steering assembly, the method comprising the steps of:
generating a torque target signal representative of the torque applied by the motor to the steering assembly, the torque target signal being proportional to a multiplication of a steering torque from the steering device;
sensing the motor current of the motor and providing a motor current signal; and
controlling the motor, whereby the motor current is driven towards a value wherein the torque target signal is equal to a multiplication factor of the motor current signal.

14. An electric power steering control system for a vehicle, the vehicle having a steering device coupled by a steering assembly to at least one tire steered by the steering device, the control system controlling a current in a motor for generating torque applied to the steering assembly, and the control system comprising:
a first component for generating a torque target signal representative of the torque applied by the motor to the steering assembly, the torque target signal being a multiplication of a steering torque from the steering device;
a motor current sensor for sensing the motor current and providing a motor current signal; and
a second component for controlling the motor, the second component receiving the torque target signal and the sensed motor signal, whereby the motor current signal is driven towards a value wherein the torque target signal is equal to a multiplication factor of the motor current signal.

15. The electric power steering control system of claim 14 further including a vehicle speed sensor providing a speed signal representative of the speed of the vehicle, and a steering angle sensor providing a steering angle signal representative of the steering angle of the steering device, wherein the vehicle speed signal and the steering angle signal are received by the second component.

16. The electric power steering control system of claim 15 wherein the means for generating a torque target signal includes means for differentiating between steering events, said means for differentiating between steering events receiving the steering torque, the vehicle speed signal and the steering angle signal.

17. The electric power steering control system of claim 14 including a third component which receives the motor current signal and generates an estimated assist torque signal.

18. The electric power steering control system of claim 17 further including a feedback component receiving the difference between the target torque signal and the estimated assist torque signal, the feedback component providing a motor control signal.

19. The electric power steering control system of claim 18 wherein the feedback component includes an integrator.

20. The electric power steering control system of claim 14 wherein the means for generating the torque target signal includes an integrator.

21. The electric power steering control system of claim 14 wherein the means for generating the torque target signal limits the torque target signal to a maximum value.

22. The electric power steering control system of claim 17 wherein the first component multiplies the motor current signal by the product of an estimated torque constant, an estimated gear efficiency and a gear ratio, the estimated gear efficiency and the gear ratio being quantitative characteristics of a gearbox coupling the motor to the steering assembly.

23. The electric power steering control system of claim 5 wherein the feedback component includes means for generating a duty cycle error signal.

24. The electric power steering control system of claim 23 wherein the feedback component further includes means for adding the duty cycle error signal to an old motor control signal, thereby generating the motor control signal.

25. An electric power steering control system for a vehicle having a steering device coupled by a steering assembly to at least one tire steered by the handle bar, the control system controlling a motor for generating torque applied to the steering assembly, the control system comprising:
a steering torque sensor for sensing steering torque generated by a driver of the steering device, the steering torque sensor providing a steering torque signal;
a vehicle speed sensor providing a vehicle speed signal representative of the vehicle speed;
a steering shaft angle sensor sensing the angular displacement of the steering device and providing a steering shaft angle signal;
a feed forward component generating an assist torque target signal representative of the torque applied to the steering assembly, the feed forward component receiving the steering torque signal, the vehicle speed signal and the steering shaft angle signal;
a current sensor for sensing the current in the motor and providing a motor current signal;
means for controlling the motor whereby the torque applied to the steering assembly is proportional to a multiplication factor of the assist torque target signal, the means for controlling the motor receiving the assist torque target signal and the motor current signal, and providing a motor control signal.

26. A method of controlling an electric power steering system for a vehicle during the return to center phase of a steering assembly of the vehicle, the electric power steering system controlling a current in a motor for generating torque applied to the steering assembly, the method comprising the steps of:
generating a torque target signal representative of the torque applied by the motor to the steering assembly, the torque target signal being proportional to a multiplication of a steering torque from the steering device;
sensing the motor current of the motor and providing a motor current signal; and
controlling the motor, whereby the motor current is driven towards a value wherein the torque target signal is equal to a multiplication factor of the motor current signal.
